(19) United States
(12) Patent Application Publication
(10) Pub. No.: US 2018/0042428 A1
(43) Pub. Date: Feb. 15, 2018

(54) DRAINAGE DEVICE

(71) Applicant: Paul Gerard Diver, Washington, DC (US)

(72) Inventor: Paul Gerard Diver, Washington, DC (US)

(21) Appl. No.: 15/673,546

(22) Filed: Aug. 10, 2017

Related U.S. Application Data
(60) Provisional application No. 62/372,921, filed on Aug. 10, 2016.

(51) Int. Cl. A47J 43/24; A47J 45/06

(52) U.S. Cl. CPC A47J 43/24; A47J 45/062

(57) ABSTRACT

A drainage device for separating fluids from solid material and evacuating the fluids so that the fluid and resulting steam is impeded from reentering the device and contaminating the solid material still remaining therein is provided. The drainage device provides an inner perforated wall defining an item cavity allows for storing the solid material, while draining the fluid therefrom. A outer solid wall connected to the inner perforated wall enables continued and directed drainage of the evacuating fluid through providing a channeling void between the outer and inner walls that fluidly communicates with a discharge opening. The discharge opening is circumscribed by a supporting neck extending from a support base, while the solidity of the outer wall provides a physical barrier against germ-carrying splashback contaminating the perforated inner wall.

### CROSS-REFERENCE TO RELATED APPLICATION

This application claims the benefit of priority of U.S. provisional application No. 62/237,921, filed 10 AUG. 2016, the contents of which are herein incorporated by reference.

### BACKGROUND OF THE INVENTION

The present invention relates to devices that strain liquid from food and, more particularly, a drainage device for evacuating liquids so that the evacuated liquid and resulting steam is prevented from reentering the device and contaminating the food stuff still remaining in the drainage device.

Items, especially consumable food, are vulnerable to contamination after liquid passes through a straining device and splashes off of a contaminated surface. As liquid is poured through a drainage device such as a colander, liquid can contact an underlying sink basin and splash back through and into the drainage device. Bacteria and germs present on the sink basin therefore can be transferred back into and contaminate the interior of the drainage device via this “splashback” liquid. Consequently, any food within the interior of drainage device can be contaminated. Furthermore, as drainage devices rest in sink basin, similarly contaminated steam may rise off of the sink basin or from the corresponding sink drain to and through the underside of drainage device, further contaminating any items contained therein.

Some current drainage devices (for example, colanders) attempt to protect from splashback contamination by raising or elevating the device sufficiently high above the sink basin. This elevation has to be maintained for the entire duration that liquid may splash back or steam may rise off the supporting sink basin. Other current drainage devices attempt to protect against contamination via a two-stage mechanism where liquid is drained away from the food item into a separate chamber and held. After this stage is complete, the first chamber was sealed and the liquid containing second chamber was opened and drained.

Elevating a device high above the sink basin is potentially dangerous and at the very least inconvenient. Raising a colander away from the sink basin by placing it on top of another item invites instability and may require large amounts of space. Manually holding a colander may require multiple people (one to hold the colander high above the sink and another to pour). A colander placed on top of another device may tip over spilling scalding liquid uncontrollably and food into the sink basin in addition to inconveniently requiring a lot of space in or around the sink and two separate devices: a colander and the elevating device. Manually holding a colander high above the sink may result in greater amount of hot liquid splashing and accidental burns or discomfort due to increased exposure to steam on hands and arms. Furthermore, a two-stage system is more labor intensive and cumbersome than one that drains liquid and protect from germs in one stage.

As can be seen, there is a need for a drainage device for retaining solid material while evacuating liquids so that the exiting liquid and resulting steam is impeded from reentering the device, wherein the device mitigates chance of failure and harm by being less prone to tip over due to its ability to be placed stably on a supporting surface, by being one item instead of two stacked on each other, by avoiding the need for unnecessary and prolonged exposure of arms and hands, by not requiring the opening and sealing of multiple chambers, by being entirely operable by one person, and by requiring no more space on and around the sink than a standard colander. The present invention is advantageous over colanders with extendable arms which rest on a countertop and suspend the colander over the sink basin, as the latter are much more unstable, and the present invention does not require support or stabilization from the countertop, rim or sink.

### SUMMARY OF THE INVENTION

In one aspect of the present invention, a drainage device for separating fluids for solid material, while preventing splashback contamination, the drainage device providing a bowl-shaped perforated inner wall defining an item cavity; a solid outer wall spaced apart from the inner so as to define a channeling void therebetween; a lower peripheral opening provided by the outer wall; and a neck extending through the lower peripheral opening so as to connect to a solid interface disposed along a lower portion of the inner wall, wherein a space between the neck and the lower peripheral wall defines a discharge opening fluidly connected to the channeling void.

In another aspect of the present invention, the drainage device providing a bowl-shaped perforated inner wall defining an item cavity; a solid outer wall spaced apart from the inner so as to define a channeling void therebetween; a lower peripheral opening provided by the outer wall; a base concentric with the lower periphery opening, the base radially extending beyond a circumference thereof by between two to four inches; and a neck extending from the base through the lower peripheral opening so as to connect to a solid interface disposed along a lower portion of the inner wall; the neck has a uniform nose-tip curvature including: a base curvature disposed below and beyond a circumference of the lower periphery opening; and an upper wall curvature disposed above and beyond said circumference, wherein a space between the neck and the lower peripheral wall defines a discharge opening fluidly connected to the channeling void.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a section view of an exemplary embodiment of the present invention, taken along line 2-2 of FIG. 1;

FIG. 3 is a section detail view of an exemplary embodiment of the present invention, taken along line 3-3 of FIG. 2;

FIG. 4 is a section detail view of an exemplary embodiment of the present invention, illustrating liquid evacuation;

FIG. 5 is a top detail perspective view of an exemplary embodiment of the present invention; and

FIG. 6 is a section detail view of an exemplary embodiment of the present invention, taken along line 6-6 of FIG. 5.

### DETAILED DESCRIPTION OF THE INVENTION

Broadly, an embodiment of the present invention provides a drainage device for separating fluids from solid material and evacuating the fluids so that the fluid and resulting steam is impeded from reentering the device and contaminating the solid material still remaining therein. The drainage device provides an inner perforated wall defining an item cavity allows for storing the solid material, while draining the fluid therefrom. A outer solid wall connected to the inner perforated wall enables continued and directed drainage of the evacuating fluid through providing a channeling void between the outer and inner walls that fluidly communicates with a discharge opening. The discharge opening is circumscribed by a supporting neck extending from a support base, while the solidity of the outer wall provides a physical barrier against germ-carrying splashback contaminating the perforated inner wall.

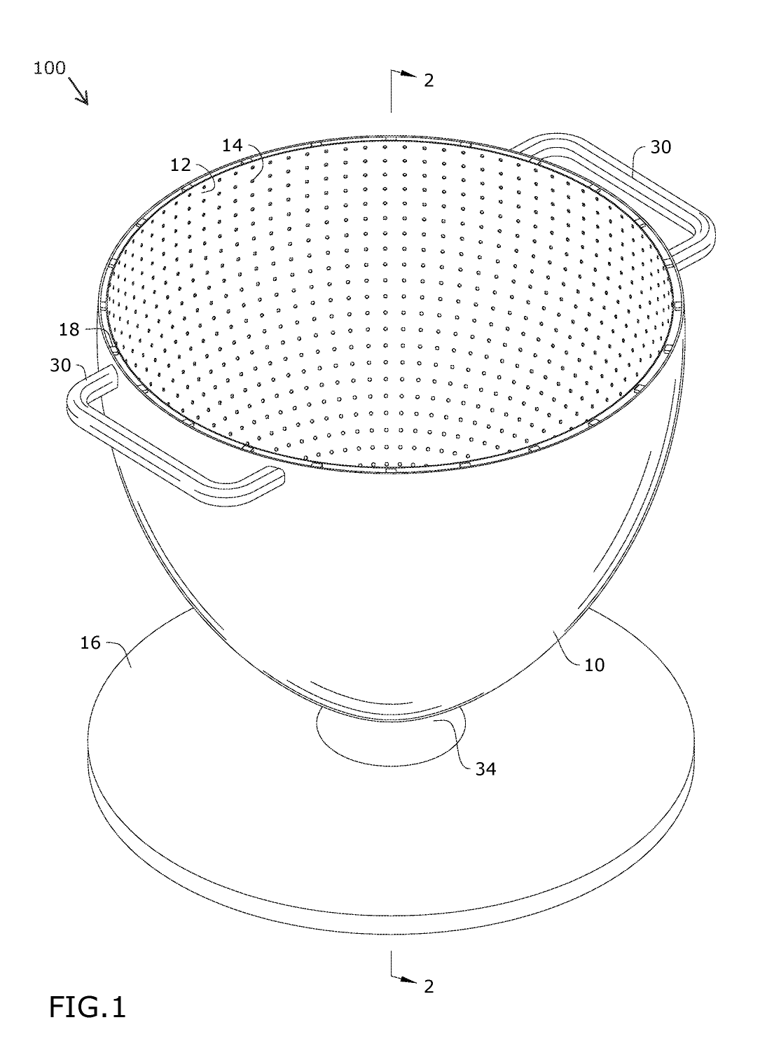

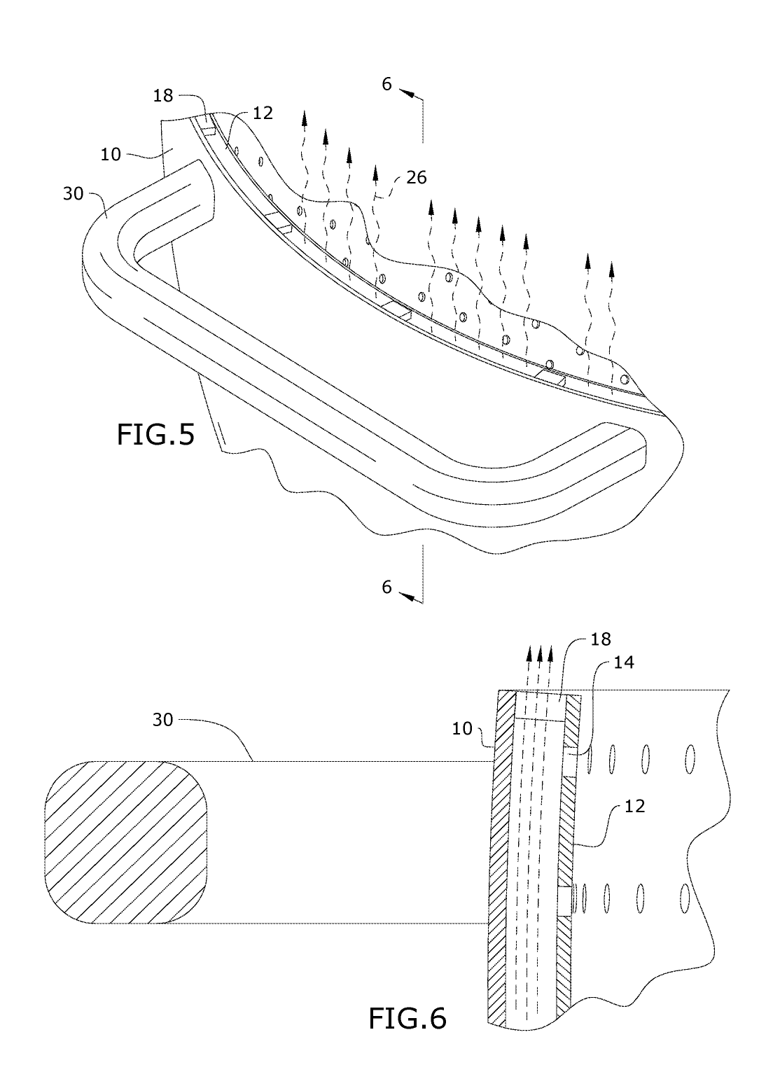

Referring now to FIGS. 1 through 6, the present invention may include a drainage device 100 having a perforated inner wall 12 connected to a spaced apart solid outer wall 10, wherein the space apart between the inner and outer walls 12 and 10 defines a channeling void 40. The perforated inner wall 12 may define an item cavity 50 for receiving food stuff 22 and fluid 24 therein, wherein the fluid flows through the perforations 14 of the perforated inner wall 12. The drainage device 100 may be made of a material with a suitably high melting point and substantial rigidity. Several materials meet these criteria (ex. certain food safe plastics and metals). Additional criteria may be the use of materials which possess anti-microbial properties. Alternatively, food safe anti-microbial treatments may be applied after manufacture of the device.

The item cavity 50 communicates to a peripheral opening in the inner wall 12, wherein the opening is defined by a peripheral edge of the inner wall 12. In certain embodiments, both inner and outer walls 12 and 10 may be substantially similarly shaped so that they both have similarly shaped item cavities, peripheral openings, peripheral edges, and the like. In other embodiments, the inner and outer walls 12 and 10 have shapes that deviate from each other, even though this may not be shown in the figures.

The present invention may provide a plurality of wall connecters 18 that interconnect the perforated inner wall 12 and the solid outer wall 10 along their associated peripheral edges, as illustrated in the Figures. The wall connectors 18 provide that the inner and outer walls 12 and 10 are spaced apart and do not abut, thus affording evacuation of fluid 24 through the channeling void 40. The inner wall 12 may provide a plurality of mounting points 38 along its outer periphery, typically below its peripheral opening, while the outer wall 10 may provide a plurality of mounting elements 36 along its inner periphery that operatively associate with the plurality of mounting points 38 when the perforated inner wall 12 operatively nests within the solid outer wall 10. The mounting element 36 may be dimensioned and adapted to securely and (in certain embodiments) removably engage the mounting point 38 so that the perforated inner wall 12 is movable between a secured condition, wherein the mounting elements and points 36 and 38 are securely engaged, and a separated condition, wherein the perforated inner wall 12 is separated from the outer wall 10.

The present invention may include a base 16 dimensioned and adapted to support the drainage device 100 on a supporting surface. A neck 34 extends upwardly from the base 16 until it connects to a lower portion of the perforated inner wall 12. It should be understood by those skilled in the art that the use of directional terms such as upper, lower, upward, downwardly, top and the like are used in relation to the illustrative embodiments as they are depicted in the figures, the upward direction (or upper) being toward the top of the corresponding figures and a downward direction being toward the bottom of the corresponding figure.

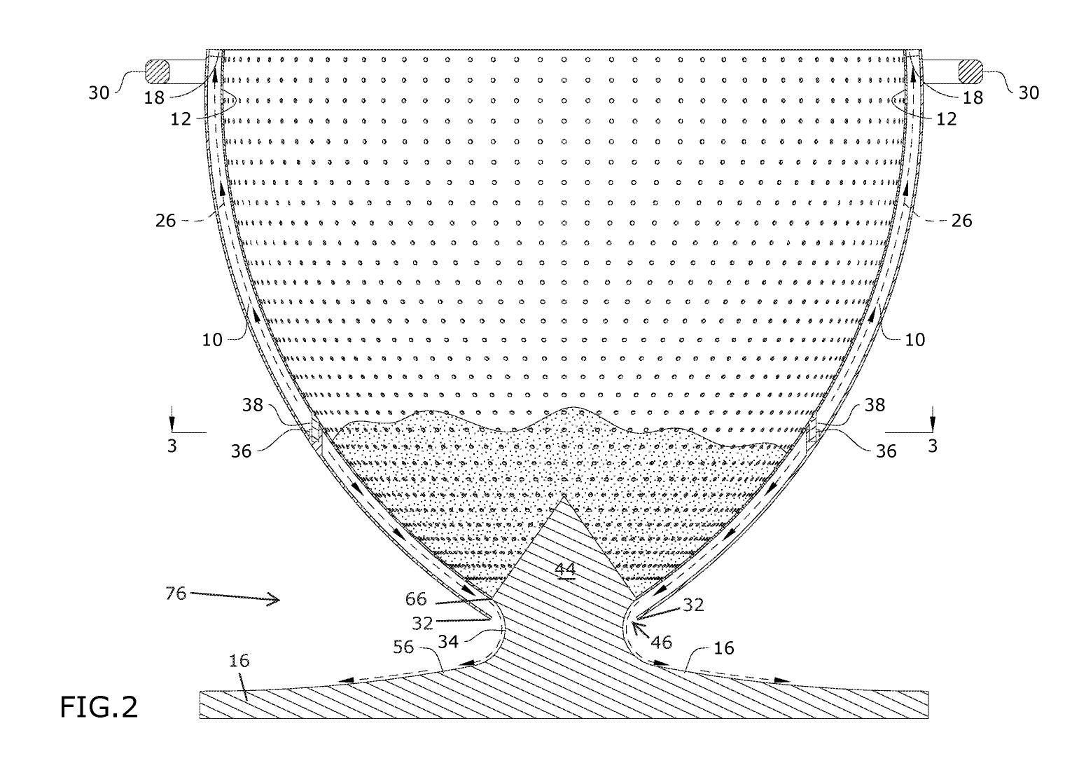

The lower portion-neck interface 44 is solid, non-perforated, preventing fluid 24 flowing therethrough. The neck 34 is spaced apart from a lower peripheral opening 32 of the solid outer wall 10, thereby defining a discharge opening 46 fluidly communicating with the channeling void 40. The neck 34 is shaped to curve from a lower base curvature 56 beginning outside a circumference of the lower periphery opening 32, curving into said circumference as it rises and passes through the lower periphery opening 32, and then curves back in the form of an upper wall curvature 66 outside said circumference above the lower periphery opening 32, wherein the neck 34 defines a generally nose-tip shape 76, as illustrated in FIG. 2.

In certain embodiments, handles 30 for lifting the discharge device 100 may be included. The handles 30 may be opposite each other and attached to the outside of the outer wall. The handles 30 may be parallel with the supporting surface.

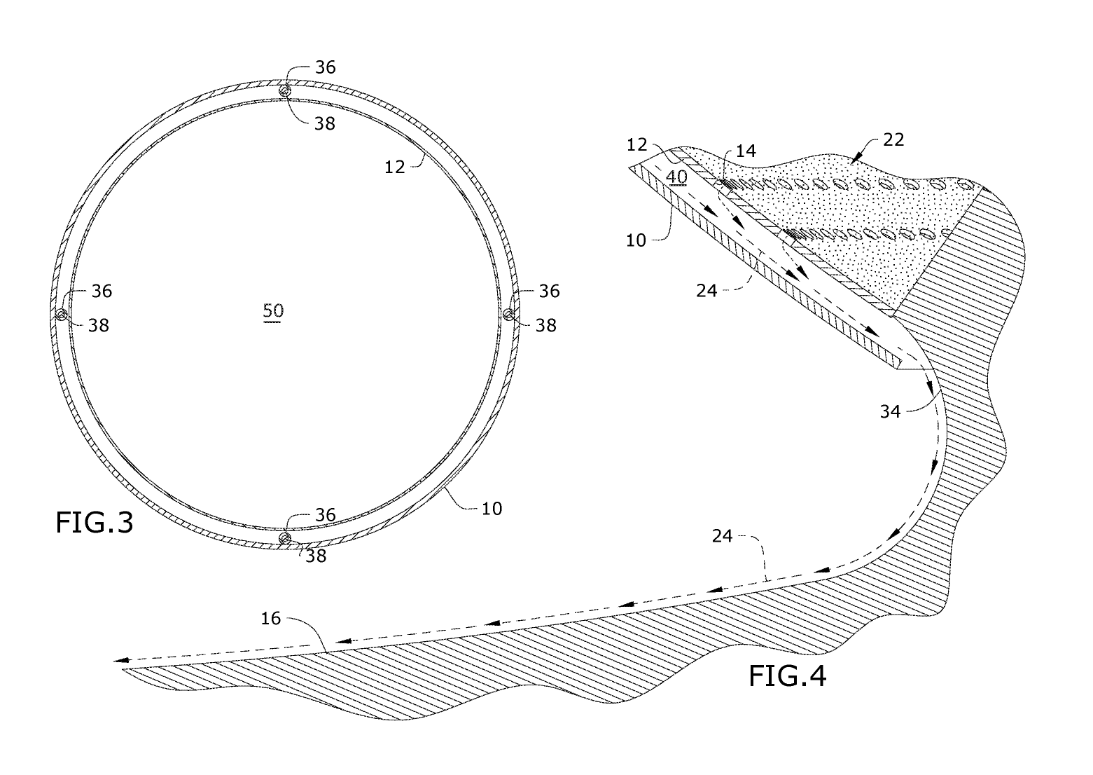

A method of using the present invention may include the following. The discharge device 100 disclosed above may be provided. A user may place the discharge device 100 on a suitable supporting surface, such as a sink basin, wherein the discharge device 100 is supported by the planar base 16. When fluids 24, food stuff or other items 22 are poured or placed into the item cavity 50 of the inner wall 12, the perforations 14 of the inner wall 12 allows for drainage of said fluid 24 away from the food stuff 22 or other items contained within the item cavity 50. The drained fluid 24 flows through the channeling void 40 between the inner perforated wall 12 and the outer solid wall 10. Guided by gravity and the shape of the outer wall 10, the fluid 24 exits the discharge opening 46 that is not occupied by the elongated neck 34, flowing along the nose-tip shape 76 of the neck 34 away from the discharge opening 46, as illustrated in FIG. 3.

The base 16 extends a peripheral distance away from said circumference of the lower peripheral opening 46. In certain embodiments, the peripheral distance is twice the diameter of said circumference, thereby thwarting splashback from accessing the discharge opening 46. In other embodiments, the base 16 can extend to over six inches from its center. Furthermore, the flow of the fluid 24 along the base 16 is at an angle relative to the discharge opening, generally perpendicular thereto, making splashback unlikely. Also, to the relatively small size of the discharge opening 46 similarly thwarts splashback. If a portion of the fluid 24 does splash back through the discharge opening 46, the nose-tip shape 76 acts as a physical barrier, impeding the splashback from contacting the perforations 14 of the inner wall 12, thereby preventing contamination of the food stuff/other items 22 still contained in the item cavity 50. For similar reasons, steam 26 rising from the supporting surface/base 16 is impeded from directly passing through the perforations 14 of the perforated inner wall 12. In other words, the downward curving splash guard neck 34 depends from the discharge opening 46 so as to divert existing fluid 24 radially, while obstructing splashback and resulting steam 26 from reentering the discharge opening 46, and if steam 26 does reenter the discharge opening 46 it may rise through the channeling void 40, bypassing the perforations 14, and exiting through the space between the upper wall peripheries.

It should be understood, of course, that the foregoing relates to exemplary embodiments of the invention and that modifications may be made without departing from the spirit and scope of the present invention.

What is claimed is:

1. A device, comprising:
a bowl-shaped perforated inner wall defining an item cavity;
a solid outer wall spaced apart from the inner so as to define a channeling void therebetween;
a lower peripheral opening provided by the outer wall; and
a neck extending through the lower peripheral opening so as to connect to a solid interface disposed along a lower portion of the inner wall,
wherein a space between the neck and the lower peripheral wall defines a discharge opening fluidly connected to the channeling void.

2. The device of claim 1, further comprising a base from which the neck extends.

3. The device of claim 1, wherein the neck has a nose-tip shaped curvature.

4. The device of claim 1, wherein the neck has a uniform nose-tip curvature comprising:
a base curvature disposed below and beyond a circumference of the lower periphery opening; and
an upper wall curvature disposed above and beyond said circumference.

5. The device of claim 2, wherein the base is concentric with the lower periphery opening, the base extends beyond a circumference of the lower periphery opening by between two to four inches.

6. The device of claim 1, further comprising:
a plurality of spaced apart mounting points along an outer periphery of the inner wall; and
a plurality of mounting elements along an inner periphery of the outer wall for operatively associating with the plurality of mounting points for maintaining the channeling void.

7. A device, comprising:
a bowl-shaped perforated inner wall defining an item cavity;
a solid outer wall spaced apart from the inner so as to define a channeling void therebetween;
a lower peripheral opening provided by the outer wall;
a base concentric with the lower periphery opening, the base radially extending beyond a circumference thereof by between two to four inches; and
a neck extending from the base through the lower peripheral opening so as to connect to a solid interface disposed along a lower portion of the inner wall; the neck has a uniform nose-tip curvature comprising:
a base curvature disposed below and beyond a circumference of the lower periphery opening; and
an upper wall curvature disposed above and beyond said circumference,
wherein a space between the neck and the lower peripheral wall defines a discharge opening fluidly connected to the channeling void.

8. The device of claim 7, further comprising a plurality of spaced apart mounting points along an outer periphery of the inner wall; and
a plurality of mounting elements along an inner periphery of the outer wall for operatively associating with the plurality of mounting points for maintaining the channeling void.
